(19) United States
(12) Patent Application Publication
(10) Pub. No.: US 2003/0107992 A1
(43) Pub. Date: Jun. 12, 2003

(54) Loop-free multipath routing method using distance vectors

(75) Inventors: Jose Joaquin Garcia-Luna-Aceves, San Mateo, CA (US); Srinivas Vutukury, Sunnyvale, CA (US)

Correspondence Address: John P. O'Banion, O'BANION & RITCHEY LLP, Suite 1550, 400 Capitol Mall, Sacramento, CA, 95814, US

(73) Assignee: THE REGENTS OF THE UNIVERSITY OF CALIFORNIA

(21) Appl. No.: 10/023,448

(22) Filed: Oct. 29, 2001

Related U.S. Application Data
(60) Provisional application No. 60/244,622, filed on Oct. 30, 2000.

(51) Int. Cl. G01R 31/08

(52) U.S. Cl. 370/230; 370/238

(57) ABSTRACT

A routing methodology for constructing multiple loop-free routes within a network of nodes executing the methodology. The method is capable of generating shortest-distance routing within the network and is not subject to the counting-to-infinity problem to which conventional distance-vector routing protocols are subject. By way of example the method comprises computing link distances Dⁱⱼ to generate routing graph SGⱼ. The nodes exchange distance and status information and upon receiving increasing distance information diffusing computations are performed. The information collected is used to maintain routing tables, from which shortest-path routes may be selected according to loop-free invariant (LFI) conditions.

### CROSS-REFERENCE TO RELATED APPLICATIONS

This application claims priority from U.S. provisional application serial No. 60/244,622 filed on Oct. 30, 2000, incorporated herein by reference.

### STATEMENT REGARDING FEDERALLY SPONSORED RESEARCH OR DEVELOPMENT

This invention was made with Government support under Grant No. F19628-96-C-0038 awarded by the Air Force Office of Scientific Research (AFOSR). The Government has certain rights in this invention.

### REFERENCE TO A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States patent and Trademark Office file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to protocols for network traffic routing, and more particularly to a loop-free multipath routing protocol based on distance vectors.

2. Description of the Background Art

Routing protocols using the “Distributed Bellman-Ford” (DBF) algorithm exhibit excessively long convergence process toward correct routes when subjected to link cost increases. A more serious deficiency of the DBF algorithm is that it is unable to converge when a set of link failures result in a network partition, which is commonly referred to as the count-to-infinity problem. Moreover, typical routing protocols utilized for the IP Internet provide a single next-hop choice for packet forwarding. The use of single-hop choices is inadequate for traffic load balancing, while it allows temporary routing loops to form during times of network transition, which diminishes network performance.

Routing may be described as the problem of determining a set of successor choices (i.e., next-hop) at each node and for each destination in the network to be used for packet forwarding. In creating a formal definition, allow a computer network to be represented as a graph G=(N, L), where N is the set of nodes (routers) and L is the set of edges (links). The set of neighbors of node i is to be given by Nⁱ. The problem consists of finding the successor set at each router i for each destination j, denoted by Sⁱⱼ⊂Nⁱ, so that when router i receives a packet for destination j, it can forward the packet to one of the neighbor routers in the successor set Sⁱⱼ. By repeating this process at every router, the packet is expected to reach the destination. If the routing graph SGⱼ is a directed subgraph of G, as defined by the link set {(m, n)|n∈Sⱼ^{m}, m∈N}, a packet destined for j follows a path in SGⱼ. Two criteria determine the efficiency of the routing graph constructed by the protocol: loop-freedom and connectivity. It is required that SGⱼ be free of loops, at least when the network is stable, because routing loops degrade network performance. In a dynamic environment, a stricter requirement is that SGⱼ be loop-free at every instant, such as if Sⁱⱼ and SGⱼ are parameterized by time t, then SGⱼ(t) should be free of loops at any time t. If there is at most one element in each Sⁱⱼ then SGⱼ is a tree and there is only one path from any node to node j. On the other hand, if Sⁱ ⱼ has more than one element, then SGⱼ is a directed acyclic graph (DAG) with greater connectivity than a simple tree, and can be utilized to enable traffic load balancing.

The importance of using a successor set instead of a single successor per destination and the need for instantaneous loop-freedom of SGⱼ has been demonstrated in recent work, in which a load-balancing routing framework is described which obtains “near-optimal” delays. A required key component of this framework is a routing protocol which responds quickly in determining multiple successor choices for packet forwarding, such that the routing graphs implied by the routing tables are free of loops even during network transitions. By load-balancing traffic over the multiple next-hop choices, congestion and delays are significantly reduced.

A number of limitations exist in the use of current Internet routing protocols. The widely deployed routing protocol RIP provides only a single next-hop choice for each destination and does not prevent temporary loops from forming. A protocol from Cisco™ referred to as EIGRP ensures loop-freedom but can guarantee only a single loop-free path to each destination at any given router. The link-state protocol known as OSPF offers a router multiple choices for packet-forwarding only when those choices offer the minimum distance. When fine granularity exists in the link cost metric, perhaps for the sake of accuracy, it is less likely that multiple paths with equal distance exist between each source-destination pair, which translates to not using the full connectivity of the network for load balancing. Also, OSPF and other similar algorithms which are based on topology-broadcast incur excessive communication overhead, often forcing network administrators to partition the network into areas connected by a backbone. This makes OSPF complex in terms of the required router configurations.

Several routing algorithms based on distance vectors have been proposed within the industry. However, with the exception of DASM (Zaumen, W. T. and Garcia-Luna-Aceves, “Loop-Free Multipath Routing Using Generalized Diffusing Computations”, Proc. IEEE INFOCOM, March 1998) which provides multiple loop-free paths per destination, all of the proposed solutions are single-path algorithms. In addition, a number of distributed routing algorithms have been proposed that use the distance and second-to-last hop to destinations as the routing information exchanged among nodes. These algorithms are often called path-finding algorithms or source-tracing algorithms. One of these path finding algorithms, referred to as LPA appears to provide greater efficiency than any of the routing algorithms based on link-state information proposed to date while it provides loop-freedom at every instant. Again, however, it should be appreciated that LPA along with the other current source-tracing algorithms provide only a single path per destination. A couple of routing algorithms have been proposed that use partial topology information, such as LVA, and ALP, to eliminate the main limitation of topology-broadcast algorithms. These routing algorithms, however, do not provide loop-freedom at every instant.

Recently, MPDA has been introduced, which appears to be the first routing algorithm based on link state information that provides multiple paths to each destination that are loop-free at every instant. Another algorithm referred to as MPATH, has been introduced which appears to be the first path-finding algorithm that constructs loop-free multipaths. Currently MPDA, MPATH, and DASM appear to offer the only practical loop-free multipath routing algorithms which are suitable for implementation within a near-optimal routing framework.

Therefore, a need exists for a routing protocol that allows the construction of loop-free multipaths, even during network transitions, while still providing collision-free communication as outlined above. The present invention satisfies those needs, as well as others, and overcomes the deficiencies of previously developed routing protocols.

### BRIEF SUMMARY OF THE INVENTION

The present invention comprises a distance vector routing methodology referred to as a “Multipath Distance Vector Algorithm” (MDVA) that computes the shortest multipath loop-free routes between each source and destination pair. In MDVA, only distance values are exchanged among neighboring routers.

By way of example, and not of limitation, in MDVA, link distances Dⁱⱼ are computed, such as by using a distributed Bellman-Ford algorithm (DBF) to generate a routing graph SGⱼ. The nodes exchange messages containing distance and status information to maintain a routing table at each node. If the distance increases for a link, or the status changes, then a diffusing computation is executed which prevents counting-to-infinity problems. Shortest path routes are selected according to loop-free invariant (LFI) conditions. The present invention solves a number of shortcomings found within current distance-vector algorithms.

An object of the invention is to provide a routing protocol for creating minimum length multipath routes within a network.

Another object of the invention is to provide a routing protocol for establishing multipath routes based on distance vectors.

Another object of the invention is to provide a method of selecting multipath routing which is not subject to loops.

Another object of the invention is to provide a method of selecting multipath routing which is not subject to counting-to-infinity problems.

Another object of the invention is to provide a routing protocol wherein the routing selections are distributed across the nodes in the given network.

Another object of the invention is to provide a multipath routing algorithm which utilizes diffusing computations to enhance performance.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a flowchart of the routing method according to an aspect of the present invention.

FIG. 2 is pseudocode for computing distance-vectors according to an aspect of the present invention, shown for processing both passive and active node states.

FIG. 3 is a topology diagram of the CAIRN network topology as utilized in simulations of the present invention.

FIG. 4 is a topology diagram of the MCI network topology as utilized in simulations of the present invention.

### DETAILED DESCRIPTION OF THE INVENTION

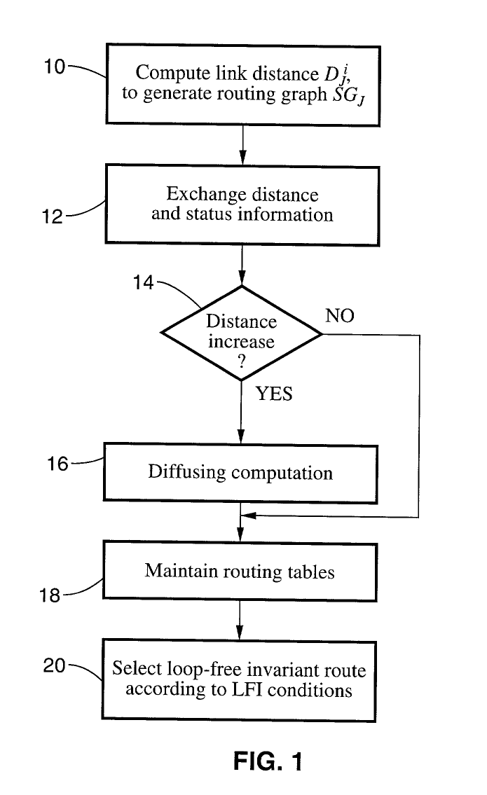

For illustrative purposes the present invention will be described with reference to FIG. 1 through FIG. 4. It will be appreciated that the apparatus may vary as to configuration and as to details of the parts, and that the method may vary as to the specific steps and sequence, without departing from the basic concepts as disclosed herein.

The present invention provides a distance vector algorithm which is referred to herein as “Multipath Distance Vector Algorithm” (MDVA) for loop-free multipath construction.

1. Multipath Distance-Vector Algorithm (MDVA)

1.1. Solution Strategy

Given that a number of potential directed acyclic graphs (DAGs) exist for a given destination within a graph, it is problematic to determine which DAG should be utilized as a routing graph. The routing graph should be uniquely defined and it should also be easily computable by the use of a distributed algorithm. A natural choice is the use of the routing graph which is defined by the shortest paths. Accordingly, MDVA defines Sⁱⱼ(t)={k|Dⱼ^{k}(t)<Dⁱⱼ(t), k∈Nⁱ}, where Dⁱⱼ is the cost of the shortest path from node i to node j as measured by the sum of the link-costs along the path. The routing graph SGⱼ implied by this set is unique and is referred to as the shortest multipath. In computing Dⁱⱼ, distributed routing algorithms may exchange any information, such as distance-vectors or link-states, although it must be assured that Dⁱⱼ will converge to the correct distances. The following formally defines what is meant as convergence. Letting G(t) denote the topology of the network as seen by an “omniscient observer” at time t, wherein Dⁱⱼ(t) denotes the distance from node i to node j in G(t), and assuming that the network has a stable configuration up to a given time t. It should be noted that all quantities within G are depicted in a larger font. It can be said that the network has converged to the correct values at t if Dⁱⱼ(t)=Dⁱⱼ(t) for all i and j. If a sequence of link cost changes were to occur between time t and t_{c}, with none occurring subsequent to t_{c}, then the routing algorithm is said to converge if at some time t_{c}<t_{f}<∞, Dⁱⱼ(t_{f})=Dⁱⱼ(t_{f})=Dⁱⱼ(t_{c}). In addition, during the convergence phase, the algorithm must ensure that the graph SGⱼ is loop-free at every instant.

According to the distributed Bellman-Ford (DBF) algorithm, each node i repeatedly executes the equation Dⁱⱼ=min{Dⁱⱼₖ+lₖⁱ|k∈Nⁱ} for a given destination j and upon each Dⁱⱼ change it reports the new distance to its neighbors. A known property of DBF is the rapid rate of convergence that occurs when link costs decrease. However, convergence is not assured in the case of increasing link-costs, and when link failures result in network partitions the DBF algorithm may never converge. The lack of convergence in this instance is known in the industry as the “counting-to-infinity problem”. Intuitively, the counting-to-infinity problem arises as a result of “circular” logic within the distance computations, wherein a node computes its distance to a destination using a distance communicated by a neighbor, which is provided as a path-length running through the node itself. The node utilizing this distance information is unaware of the circular logic because the nodes exchange distance information and not path information.

The circular computation of distances that occur in DBF can be prevented if distance information is propagated along a DAG rooted at a destination. Given a DAG, each node computes its distance using distances reported by the “downstream” nodes and reports its distance to “upstream” nodes. This method, referred to as diffusing computations was first suggested by Dijkstra et. al. to ensure termination of distributed computation. It will be appreciated that a diffusion computation always terminates due to the acyclic ordering of the nodes. The base algorithm for EIGRP is DUAL which utilizes diffusing computation to solve the counting-to-infinity problem. In addition to DUAL, a number of other distance vector algorithms have been proposed which employ diffusing computations to overcome the counting-to-infinity problem of DBF. The algorithm suggested by Jaffe and Moss allows nodes to participate in multiple diffusing computations for the same destination and requires use of unbounded counters, which render the method impractical. In contrast, a node in DUAL and DASM participates in only one diffusing computation for any destination at any single time and thus requires only the use of a toggle bit. The present invention, MDVA follows the second approach.

Two issues arise regarding diffusing computation: (1) since many potential DAGs exist for a given destination, the selection of which one to use for the diffusing computation is difficult; (2) how to implement diffusing computations in a dynamic environment in which the chosen DAG changes with respect time.

The following describes resolutions for these issues. Resolving the first issue is straightforward as the shortest multipath SGⱼ provides a correct choice given that computing SGⱼ is the final objective. The resolution, however, of the second issue is not so trivial. A routing graph SGⱼ utilized for carrying out a diffusing computation can be allowed to change if the following conditions are met: (1) SGⱼ is acyclic at every instant, and (2) at any given instant, if a node reports a distance through a neighbor k in Sⁱⱼ it must ensure that k remains in Sⁱⱼ until the end of the diffusing computation. The prevention of a circular computation of distances can be inferred from the following argument. Assume first that a circular computation occurs at time t involving nodes i₀, i₁, i₂, . . . iₘ. Let a node iₚ, wherein 1≦p≦m, compute its distance at tₚ<t using distance reported by iₚ₋₁, and i₀ computes its distance using the distance reported by iₘ at t₀. Because iₚ₋₁ is held in the successor set of iₚ for 1≦p≦m and i₀ holds iₘ until the diffusing computation ends, therefore it follows that:

i₀∈Sⁱ^{₁}ⱼ(t₁)→i₀∈Sⁱ^{₁}ⱼ(t)

i₁∈Sⁱ^{₂}ⱼ(t₂)→i₁∈Sⁱ^{₂}ⱼ(t)

iₘ₋₁∈Sⱼ^{m}(tₘ)→iₘ₋₁∈Sⱼ^{m}(t)

iₘ∈Sⱼ⁰(t₀)→iₘ∈Sⱼ⁰(t)

Because SGⱼ(t), as implied by Sⁱⱼ(t), is acyclic at every instant t, the above relations would indicate a contradiction. Thus, the circular computation is impossible when observing the above mentioned conditions. It should be noted that the distances are to be propagated along the shortest-multipath SGⱼ which is computed using the distances itself. This “bootstrap” approach is the core of the MDVA algorithm, which involves computing Dⁱⱼ using diffusing computations along SGⱼ while simultaneously constructing and maintaining routing graph SGⱼ.

In order to ensure that SGⱼ is always loop-free a new variable feasible distance FDⁱⱼ is introduced. The feasible distance FDⁱⱼ is an “estimate” of the distance Dⁱⱼ in the sense that FDⁱⱼ is equal to Dⁱ ⱼ when the network is in stable state. However, in order to prevent loops during periods of network transitions, the value of FDⁱⱼ is allowed to differ temporarily from Dⁱⱼ. Let Dⁱⱼₖ be the distance of k to j as notified to i by k. To ensure loop-freedom at every instant FDⁱⱼ, Dⁱⱼₖ, and Sⁱⱼ must satisfy the “Loop-Free Invariant” (LFI) conditions which were first introduced in regard to approximating minimum delay routing. The LFI conditions capture all previous loop-free conditions in a unified form that simplifies protocol design and correctness proofs, comprising:

FDⁱⱼ(t)≦D^{k}ⱼᵢ(t)k∈Nⁱ (1)

Sⁱⱼ(t)={k|Dⁱⱼₖ(t)<FDⁱⱼ(t)} (2)

The invariant conditions (1) and (2) state that, for each destination j, a node i can choose a successor whose distance to j, as known to i, is less than the distance of node i to j that is known to its neighbors.

Theorem 1: If the LFI conditions are satisfied at any time t, the SGⱼ(t) implied by the successor sets Sⁱⱼ(t) are loop free.

Proof:

Let k∈Sⁱⱼ(t) then from (2):

Dⁱⱼₖ(t)<FDⁱⱼ(t) (3)

At node k, in view of node i being a neighbor and from (1) we arrive at FDⱼ^{k}(t)≦Dⁱⱼₖ(t), which when combined with Eq. 3 yields:

FDⱼ^{k}(t)<FDⁱⱼ(t) (4)

It will be appreciated that Eq. 4 states that if k is a successor of node i in a path to destination j, then the feasible distance to j which is known to k is strictly less than the feasible distance of node i to j. Now, if the successor sets define a loop at time t with respect to j, then for some node p on the loop, we arrive at the absurd relation FDⱼ^{p}(t)<FDⱼ^{p}(t). Therefore, the LFI conditions have been shown to be sufficient to assure loop-freedom.

The above theorem suggests that any distributed routing protocol, such as link-state or distance-vector, which attempts to determine loop-free shortest multipaths is required to compute Dⁱⱼ, FDⁱⱼ, and Sⁱⱼ such that the LFI conditions are satisfied, and such that at convergence Dⁱⱼ=FDⁱⱼ=minimum distance from i to j.

1.2. Algorithm Description

FIG. 1 depicts the general flow for the method of the present invention. Link distances Dⁱⱼ are computed at block 10 to generate a routing graph SGⱼ. The nodes in the network exchange distance and status information as per block 12. If a distance increase is detected at block 14 then a diffusing computation is performed as shown in block 16. The distance and status information is used to maintain routing tables within each node as per block 18 so that the proper selection of a loop-free route is determined according to loop-free invariant conditions as shown in block 20.

The MDVA algorithm utilizes DBF to compute distance Dⁱⱼ, and thus routing graph SGⱼ while always propagating distances along the routing graph SGⱼ to prevent counting-to-infinity problems and to otherwise ensure termination. Each node maintains a main table containing Dⁱⱼ as the distance of node i to destination j. The table also stores for each destination j, the successor set Sⁱⱼ, the feasible distance FDⁱⱼ, the reported distance RDⁱⱼ, and the shortest distance possible through the successor set Sⁱⱼ as best distance SDⁱⱼ. In addition, the table stores QSⁱⱼ⊂Sⁱⱼ, as the set of neighbors involved in a diffusing computation. Each node maintains a neighbor table for each neighbor k which contains Dⁱⱼₖ as the distance of neighboring node k to node j as communicated by node k. A link table stores the link-cost lₖⁱ of adjacent links to each neighbor k. If a link is down its link-cost is considered to increase to infinity and the distance to unreachable nodes is also considered to be infinity.

Nodes executing the MDVA algorithm exchange information using messages containing at least one entry of the form [type, j, d], where d is the distance of the node sending the message to destination j. The type field comprises messages such as QUERY, UPDATE, REPLY, or equivalents. It is assumed that messages transmitted over an operational link are received without errors and in the proper sequence, and that the messages are processed in the order received.

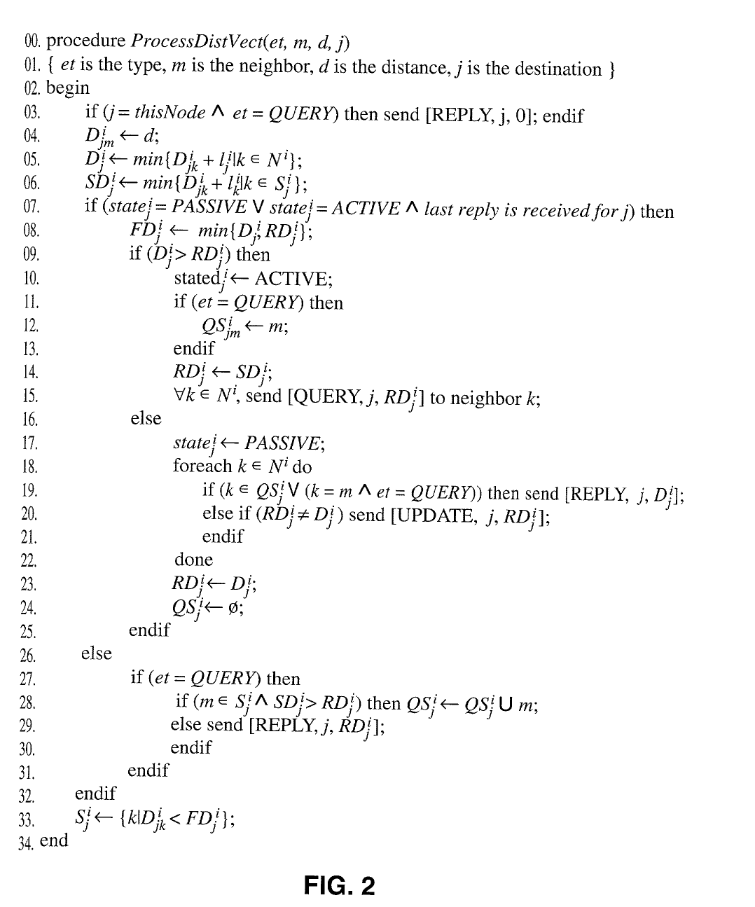

Nodes invoke the procedure ProcessDistVect as shown in FIG. 2 to process a distances vector when an event occurs. An event may be considered as the arrival of a message, a change in the cost of an adjacent link, or a change in status (up/down) of an adjacent link. When an adjacent link is brought up, the node sends an update message [UPDATE, j, RDⁱⱼ] for each destination j over the link. When an adjacent link (i, m) fails, the neighbor table associated with neighbor m is cleared and the cost of the link is set to infinity. Then for each destination, the procedure ProcessDistVect(UPDATE, m, ∞, j) is invoked. Similarly, when an adjacent link cost to m changes, the cost lₘⁱ, is set to the new cost and ProcessDistVect(UPDATE, m, Dⁱⱼₘ, j) is invoked for each destination j. When a message is received, ProcessDistVect( ) is invoked for each entry of the message.

A node initializes the distance values in its tables to infinity and its sets to null at the startup time. In view of the fact that the distances can be computed independently to each destination, the remainder of the description describes the operation of the algorithm with respect to a particular destination j. A node can be in ACTIVE or PASSIVE state with respect to a destination j represented by a variable state. A node is considered active when it is engaged in a diffusing computation. Assume first that all nodes are PASSIVE. While link costs decrease, MDVA essentially operates like DBF, because the condition on line 9 always fails wherein lines 17-24 are always executed. ProcessDistVect( ) operates in such a way that when the node is in a PASSIVE state, the condition Dⁱⱼ=FDⁱⱼ=RDⁱⱼ=min{Dⁱⱼₖ+lₖⁱ|k∈Nⁱ} always holds as can be seen from lines 8 and 23. However, if the distance to a destination increases either because the cost of an adjacent link changes or a message is received from a neighbor, the condition on line 9 succeeds and the node engages in a diffusing computation. This is accomplished by sending query messages to all the neighbors with the best distance through the subset of neighbors Sⁱⱼsuch as SDⁱⱼ, and waiting for the neighbors to reply (lines 14-15). The node is said to be in an ACTIVE state when it is waiting for the replies. If the increase in distance is due to a query from a successor, the neighbor is added to QSⁱⱼ so that a reply can be given when the node transits to a PASSIVE state. When all replies are received, the node can be sure that the neighbors have the distances that the node reported and are ready to transition to the PASSIVE state. At this point, FDⁱⱼ can be increased and new neighbors can be added to Sⁱⱼ without violating the LFI conditions.

If a query message is received from a neighbor which is not in the successor set for a node in an ACTIVE state, then a reply is given immediately. However, if the query is from a neighbor m in Sⁱⱼ, a test is performed to verify if SDⁱⱼ increased beyond the previously reported distance, (line 28). If it did not increase beyond the limit then a reply is sent immediately. However, if SDⁱⱼ increased, the query is blocked by adding m to QSⁱⱼ and no reply is given. The replies to neighbors in QSⁱⱼ are deferred until that time when the node is ready to transition to the PASSIVE state. After receiving all replies the ACTIVE phase can either end or continue. If the distance Dⁱⱼ is increased again after receipt of all replies, the ACTIVE phase will be extended by sending a new set of queries, otherwise the ACTIVE phase will terminate. For the case of ACTIVE phase continuation, no replies are issued to the pending queries in QSⁱⱼ. Otherwise, all replies are given and the node transits to PASSIVE state satisfying the PASSIVE state invariant Dⁱⱼ=FDⁱⱼ=RDⁱⱼ=min{Dⁱⱼₖ+lₖⁱ|k∈Nⁱ}.

2. Verifying Correctness of MDVA

The correctness of MDVA is proven for two scenarios: (1) subject to link cost decreases only, and (2) subject to some link cost increases as a result of increasing link distances. MDVA operates in a similar manner to DBF when link costs are only subject to decreases and the same proofs utilized for DBF apply. To state this formally, assume that the network is stable preceding a time t, wherein all nodes have obtained correct distances, and then at time t, the costs of a portion of the links decrease. Since the distances in the tables are such that Dⁱⱼ(t)≧Dⁱⱼ(t), within some finite time t′, t≦t′<∞, and Dⁱⱼ(t′)=Dⁱⱼ(t). The distinction between Dⁱⱼ and Dⁱⱼ should be noted, as Dⁱⱼ is the correct distance while Dⁱⱼ is just a local variable i and is an estimate of Dⁱⱼ. It will be appreciated that by using the present routing protocol that Dⁱⱼ must eventually equal Dⁱⱼ, barring continuous changes to Dⁱⱼ.

Subject to some link cost increases, wherein distances between a portion of the source-destination pairs increase, MDVA and DBF behave differently. In this case, Dⁱⱼ(t)<Dⁱⱼ(t) for some i and j. Both DBF and MDVA first increase Dⁱⱼ to a value greater than Dⁱⱼ(t), after which the distances monotonically decrease until they converge to the correct distances. MDVA and DBF, however, differ on how they increase the distances. DBF executes the increase step-by-step in small bounded increments until Dⁱⱼ(t)≧Dⁱⱼ(t). Unfortunately, when Dⁱⱼ(t)=∞ counting-to-infinity is encountered. In contrast, MDVA executes diffusing computations to quickly raise Dⁱⱼ so that Dⁱⱼ≧Dⁱⱼ(t), after which the functioning is similar to scenario described above, and the distances converge to the correct values as before.

In summary, to show that MDVA terminates correctly, it can be shown that (1) the routing graph SGⱼ is loop-free at every instant; (2) every diffusing computation using routing graph SGⱼ completes in finite time; and (3) a finite number of diffusing computations are executed. After performing all diffusing computations the MDVA algorithm becomes similar to conventional DBF.

Theorem 2: For a given destination j, the routing graph SGⱼ constructed by MDVA is loop free at every instant.

Proof:

The proof proceeds by illustrating that the LFI conditions are satisfied during every ACTIVE and PASSIVE phase. Let tₙ be the time when the n^{th} transition to ACTIVE state starts at node i for j. The proof is by induction on tₙ. At node initialization time 0, all distance variables are initialized to infinity and hence FDⁱⱼ(0)≦Dⁱⱼₖ(0), and k∈Nⁱ. The following is valid assuming that LFI conditions hold true up to time tₙ.

FDⁱⱼ(t)≦Dⁱⱼₖ(t)t∈[0, tₙ] (5)

At any time t, from lines 6, 8, 14 and 23 in the pseudocode in FIG. 2, and as a result of SDⁱⱼ(t)≧Dⁱⱼ(t), it follows that:

FDⁱⱼ(t)≦RDⁱⱼ(t) (6)

and therefore, for tₙ₋₁ and tₙ, we arrive at:

FDⁱⱼ(tₙ₋₁)≦RDⁱⱼ(tₙ₋₁) (7)

FDⁱⱼ(tₙ)≦RDⁱⱼ(tₙ) (8)

Let queries be sent at tₙ, the start time of the n^{th} ACTIVE phase, to be received at a particular neighbor k at t′>tₙ. From Eq. 6 and from the fact that if any update messages have been sent between tₙ₋₁ and t₀, they are non-increasing, whereby it follows that:

FDⁱⱼ(t)≦Dⁱⱼₖ(t)t∈[tₙ, t′] (9)

The variable t″ is used to represent the time when all replies are received and the ACTIVE phase ends. During the ACTIVE phase the value of FDⁱⱼ remains unchanged and no new RDⁱⱼ is reported during this period (line 27-31), while during the PASSIVE phase only decreasing values of RDⁱⱼ are reported. The following may then be derived from Eq. 8:

FDⁱⱼ(t)≦Dⁱⱼₖ(t)t∈[t′, t″] (10)

Irrespective of whether the node transitions to the PASSIVE state or continues in the ACTIVE phase, at time t″ the following is known from Eq. 6:

FDⁱⱼ(t″)≦RDⁱⱼ(t″) (11)

In the case that the ACTIVE phase finally terminates, we arrive at FDⁱⱼ(t)≦Dⁱⱼₖ(t) for t∈[tₙ, t″]. In the PASSIVE state, RDⁱⱼ is can only decrease until the next ACTIVE phase at tₙ₊₁. Therefore, the LFI conditions are satisfied in the interval [tₙ, tₙ₊₁]. Alternatively, if the ACTIVE state continues then new queries are sent at t″. Assuming that all replies for these queries are received at t′″, and from a similar argument as above, it follows that FDⁱⱼ(t)≦Dⁱⱼₖ(t) for t∈[tₙ, t′″]. It will be appreciated, therefore, that irrespective of the duration of the ACTIVE phase the invariant holds between the times [tₙ, tₙ₊₁]. As a consequence of which, by induction the LFI conditions hold at all times. It follows from Theorem 1 that routing graph SGⱼ is loop-free at all times.

Lemma 1: Every ACTIVE phase is subject to a finite duration.

Proof:

An ACTIVE phase may never end due to either “deadlock” or “livelock”. It will be recognized that a node transitioning to the ACTIVE state, with respect to a given destination, will transmit queries. If the transition occurs as a result of a query from a successor, the node defers the reply to this query until it receives the replies to its own queries. An issue of “circular” waits arises as a consequence of nodes awaiting replies to their own queries before replying to a query from a neighbor. It should be recognized that “circular” waits can lead to deadlock conditions. However, in the present invention “circular” waits are prevented for the following reasons. Firstly, a node in the passive state immediately replies to a query from a predecessor (lines 19). If the query is from a successor that potentially increases SDⁱⱼ, and the node is ACTIVE, the query is held until the ACTIVE phase ends (line 29). As a result of the routing graph SGⱼ being loop-free at every instant, as illustrated by the proof to Theorem 2, a deadlock condition cannot occur. Thus a node issuing queries to its neighbors will eventually receive all the replies and transition to the PASSIVE state.

A livelock is a situation in which a node endlessly has continuous back-to-back ACTIVE phases without ever being able to reply to the pending queries from its successors. It will be appreciated that a livelock also is not possible within the present system for the following reasons. An ACTIVE phase transition occurs either because of a query from a successor or a link-cost increase of an adjacent link. A query from a successor is blocked if it increases best distance SDⁱⱼ. Since links can change only a finite number of times and a finite number of neighbors exist for each node from which the node can receive queries, the node can only enter a finite number of back-to-back active phases. A node eventually sends all pending replies and enters the PASSIVE state, wherein livelock is not possible.

Lemma 2: A node can have only a finite number of ACTIVE phases.

Proof:

It is assumed for the sake of contradiction that a node does exist which proceeds through an infinite number of PASSIVE to ACTIVE transitions. An active phase transition occurs either because of a query from a successor or a link-cost increase of an adjacent link. The infinite PASSIVE-ACTIVE phase transitions must be triggered by an infinite number of queries from a neighbor, because link costs can change only a finite number times. Let that neighbor be represented by node k. Now, by the same argument, node k is sending infinite queries because it is receiving infinite queries. However, this argument cannot be continued indefinitely because there are only finite number of nodes in the network. Since the reply to the neighbor in the successor set causing the phase transition is blocked, and the routing graphs are loop-free at every instant (Theorem 2), there must exist a node that transitions to the ACTIVE state only because of adjacent link cost changes. This implies a link changes cost an infinite number of times which is a contradiction of the assumption, which proves that a node cannot have infinite ACTIVE phases.

Theorem 3: After a finite sequence of link-cost changes in the network, the distances Dⁱⱼ converge to the final correct values Dⁱⱼ.

Proof:

Assume at time 0 that every node has correct values for all link distances. In other words, Dⁱⱼ(0)=Dⁱⱼ(0). Assume a finite number of link cost changes, link failures and link recoveries occurring in the network between time 0 and time t_{c}, and after time t_{c} that no additional changes occur. It must be shown that at some time t_{f}, such that t_{c}≦t_{f}≦∞, wherein all nodes converge to the correct distances given by Dⁱⱼ(t_{f})=Dⁱⱼ(t_{c})=Dⁱⱼ(t_{f})

From Lemma 1 and 2, it follows that all nodes, within a finite time after the last link change will transition to the PASSIVE state and remain in PASSIVE state thereafter. Therefore, let t′ be the time when the last ACTIVE phase ends in the network, wherein the following are to be proven.

1. Dⁱⱼ(t′)≧Dⁱⱼ(t_{c}) forevery i and j.

2. In the time period between time t′ and time t_{f}, every distance Dⁱⱼ monotonically decreases and eventually converges at time t_{f} to the correct distances Dⁱⱼ(t_{c}). Wherein Dⁱⱼ(t_{f})=Dⁱⱼ(t_{c}).

Proof, Part 1:

Assume towards a contradiction that Dⁱⱼ(t′)<Dⁱⱼ(t_{c}). Let Dⁱⱼ(t′)=(lₖⁱ(t′)+Dⁱⱼₖ(t′)) for some k∈K⊂Nⁱ. Assume Dⱼ^{k}(t′)≦Dⱼ^{k}(t_{c}), and that K has only one element. Because Dⁱⱼ(t_{c})=lₖⁱ(t_{c})+Dⱼ^{k}(t_{c}) we have lₖⁱ(t′)+Dⁱⱼₖ(t′)≦lₖⁱ(t_{c})+Dⱼ^{k}(t′) from which we can infer that either lₖⁱ(t′)<lₖⁱ(t_{c}) or Dⁱⱼₖ(t′)<Dⱼ^{k}(t′) or both. If lₖⁱ(t′)<lₖⁱ(t_{c}), it implies that the link cost of (i, k) is not yet increased to lₖⁱ(t_{c}) via a link-cost change event. When it does, the condition on line 9 becomes true and an ACTIVE state transition is triggered, and all ACTIVE phases have not terminated. Similarly, if Dⁱⱼₖ(t′)<Dⱼ^{k}(t′), then messages are in-transit that when processed by node i would trigger a PASSIVE-to-ACTIVE transition. Thus, the ACTIVE phases have not ended, which contradicts the original erroneous assumption. Therefore, when ACTIVE phases end Dⁱⱼ(t′)≧Dⁱⱼ(t_{c}). When K has more than one element, each element will be sequentially removed from the successor set without triggering the ACTIVE transition until the last element, at which time the ACTIVE state transition finally occurs.

Proof Part 2:

After every node becomes PASSIVE at time t′, all the messages in-transit can only decrease the distances; otherwise, that would result in a transition to an ACTIVE state. At this stage MDVA works essentially like DBF and the same proof of DBF applies here. Each time a distance is decreased, the new distance is reported. The distances will eventually converge, because distances cannot decrease forever and are bounded on the lower end by Dⁱⱼ(t_{c}).

3. Evaluating the Performance of MDVA

The storage complexity is determined by the amount of table space needed by any given node. Each one of the Nⁱ neighbor tables and the main distance table has size of the order O(|Nⁱ∥N|). The storage complexity is, therefore, of the order O(|N|). The computation complexity is the time taken to process a distance vector and it is easy to see that processDistVector( ) requires execution time given by O(|Nⁱ|). The time complexity is the time it takes for the network to converge after a set of link-cost changes occur within the network. The communication complexity is the amount of message overhead required for propagating a set of link-cost changes. In a dynamic environment, the timing and range of link-cost changes occur in complex patterns and is often determined by the nature of the traffic on the network. Thus, obtaining expressions for time complexity and communication complexity in closed form is not possible, and only approximations are provided for the case in which communication is synchronous throughout the network.

Accordingly, simulations are utilized to compare the worst case performance, in terms of control overhead and convergence times, of MDVA with those of DBF and MPATH. The purpose of these simulations is to yield qualitative explanations for the behavior and performance of MDVA. The reason for choosing DBF as a benchmark is that it does not use diffusing computations and yet is based on vectors of distances. The reason for choosing MPATH is that it has been shown to be very efficient, in terms of communication overhead and convergence times, compared against prior algorithms based on link-state information and distance information, such topology broadcast, DASM, LVA, ALP. Thus DBF and MPATH represent two ends of the performance spectrum.

MDVA achieves loop-freedom through diffusing computations that, in some cases, may span the whole network. In contrast, MPATH uses only neighbor-to-neighbor synchronization. It is interesting to see how convergence times are effected by the synchronization mechanisms. Also, it is not obvious how the control message overheads of MDVA and MPATH compare.

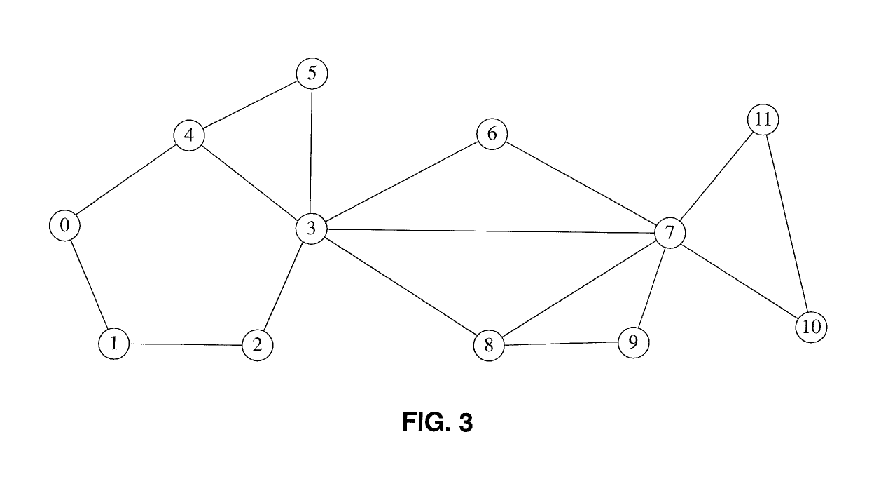

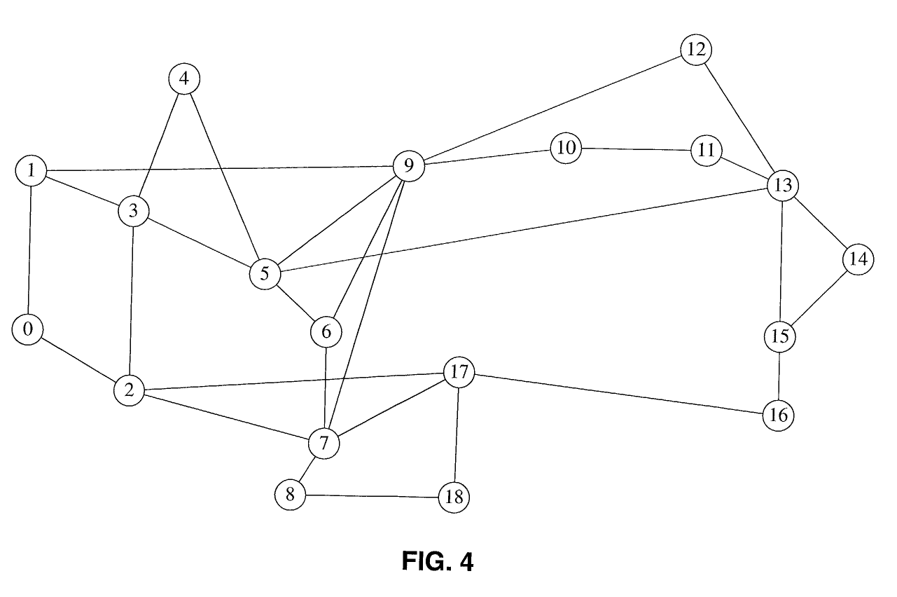

The performance metrics used for comparison are the control message overhead and the convergence times. It is assumed that the computation times are negligible in relation to the communication times. The simulator utilized was an event-driven real-time simulator called CPT. Simulations are performed on the CAIRN and MCI topology shown in FIG. 3 and FIG. 4 respectively. The bandwidth and propagation delays of each link are given in parenthesis next to the topology. In backbone networks the links and nodes are highly reliable and change status much less frequently than link costs which are a function of the traffic on the link. This is particularly true when near-optimal delay routing is utilized, in which the link costs are periodically measured and reported. For these reasons, the algorithms are compared when multiple link-cost changes occur. Link costs are chosen randomly within a range and link-cost change events are triggered, at which time the algorithms are allowed to converge. The worst case message overhead and convergence times are shown in Table 2 and Table 3 respectively. MDVA provides a performance increase over DBF by virtue of the utilization of diffusing computations for increasing distances. MPATH was found to achieve higher performance than MDVA in the majority of instances, although, at times MDVA outperformed MPATH as can be seen for MCI(0.1 mS, 10 Mb), which generally occurs when link-cost changes are largely link decreases as distance-vector algorithms are known to converge rapidly when link-costs decrease.

Accordingly, it will be seen that this invention presents a new distributed distance-vector routing algorithm which provides multiple next-hop choices for each destination wherein the routing graphs implied by the multiple next-hop choices are always loop-free. The present invention utilizes a set of loop-free invariant conditions that ensure correct termination of the algorithm and eliminate counting-to-infinity problems. The multiple successors that MDVA makes available at each node can be used for traffic load-balancing. It has been shown utilizing other known algorithms, such as MPDA, that loop-free multiple paths are necessary in order to minimize the delays encountered within the network. It will be appreciated, therefore, that MDVA can be utilized as an alternative to MPDA to approximate minimum-delay routing in networks.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Reference for Notations

| | |
|---|---|
| N | Set of nodes in the network |
| Nⁱ | Set of neighbors for node i |
| Sⱼⁱ | Subset of Nⁱ that node i forwards packets of destination j |
| SGⱼ | Routing graph implied by the successor sets of destination j |
| Dⱼⁱ | Distance of node i to node j as known to node i |
| lₖⁱ | Cost of link (i, k) |
| Dⱼₖⁱ | Distance of node k to j as reported to node i by node k |
| FDⱼⁱ | Feasible distance is an estimate of Dⱼⁱ |
| RDⱼⁱ | Distance to j as reported by node i to its neighbors |
| SDⱼⁱ | Best distance to j through Sⱼⁱ |
| QSⱼⁱ | Set of neighbors that are awaiting replies |
| G(t) | An overview of the network at time t |
| Dⱼⁱ(t) | Distance of node i to node j in G(t) |
| lₖⁱ(t) | Cost of link (i, k) in G(t) |

TABLE 2
Overhead Loading

| | DBF | MDVA | MPATH |
|---|---|---|---|
| Topology and conditions | Message Load (bits) | | |
| MCI (10 mS, 10 Mb) | 62568 | 52352 | 32408 |
| MCI (0.1 mS, 10 Mb) | 78624 | 52840 | 32408 |
| CAIRN (10 mS, 10 Mb) | 39648 | 14056 | 6176 |
| CAIRN (0.1 mS, 10 Mb) | 37208 | 12992 | 5640 |

TABLE 3
Convergence Times

| | DBF | MDVA | MPATH |
|---|---|---|---|
| Topology and conditions | Conversion Time in milliseconds (mS) | | |
| MCI (10 mS, 10 Mb) | 330.51 | 250.46 | 190.72 |
| MCI (0.1 mS, 10 Mb) | 4.36 | 2.51 | 2.62 |
| CAIRN (10 mS, 10 Mb) | 470.61 | 170.31 | 150.32 |
| CAIRN (0.1 mS, 10 Mb) | 4.07 | 2.14 | 1.82 |

What is claimed is:

1. A method for loop-free multipath routing in a network of interconnected router nodes, comprising:
computing shortest multipath loop-free route distances between a source and corresponding destination using loop-free invariant conditions; and
exchanging distance values among neighboring routers;
wherein said loop-free invariant conditions prevent a count-to-infinity problem and ensure termination of said computing of loop-free route distances.

2. A method as recited in claim 1, further comprising:
generating a routing graph from said route distances.

3. A method as recited in claim 1, further comprising:
if the distance increases for a route, executing a diffusing computation.

4. A method as recited in claim 1, further comprising:
providing multiple next-hop choices for each destination.

5. A method as recited in claim 1, wherein nodes exchange messages containing distance information to maintain a routing table at each node.

6. A method as recited in claim 1, wherein ordering of messages from rapidly changing sources is supported for overlapping receiver groups and for anonymous hosts.

7. A method as recited in claim 1, further comprising:
distributing ordering among a plurality of nodes across a logical tree.

8. A method as recited in claim 7, further comprising:
using aggregation of ordering primitives to minimize control traffic among nodes.

9. A method as recited in claim 7, further comprising:
using address extensions assigned to hosts for self-routing of messages and dynamic distribution of processing load for said ordering.

10. A method as recited in claim 9, further comprising:
using said address extensions, supporting total ordering of messages for anonymous and overlapping receiver groups in shared trees.

11. A m method for loop-free multipath routing in a network of interconnected router nodes, comprising:
computing shortest multipath loop-free route distances between a source and corresponding destination according to loop-free invariant (LFI) conditions that prevent a count-to-infinity problem and ensure termination of said computing of said loop-free route distances;
exchanging distance values among neighboring routers; and
if the distance increases for a route, executing a diffusing computation.

12. A method as recited in claim 11, further comprising:
generating a routing graph from said route distances

13. A method as recited in claim 11, wherein nodes exchange messages containing distance information to maintain a routing table at each node.

14. A method as recited in claim 11, wherein ordering of messages from rapidly changing sources is supported for overlapping receiver groups and for anonymous hosts.

15. A method as recited in claim 11, further comprising:
distributing ordering among a plurality of nodes across a logical tree.

16. A method as recited in claim 15, further comprising:
using aggregation of ordering primitives to minimize control traffic among nodes.

17. A method as recited in claim 15, further comprising:
using address extensions assigned to hosts for self-routing of messages and dynamic distribution of processing load for said ordering.

18. A method as recited in claim 17, further comprising:
using said address extensions, supporting total ordering of messages for anonymous and overlapping receiver groups in shared trees.

19. A method of determining loop-free multipath routes within a network of interconnected router nodes executing a routing protocol, comprising:
compute link distance between a source and destination;
exchanging distance and status information between said nodes;
executing a diffusing computation if the distance of a link to a destination increases;
maintaining a set of routing tables containing information about distance, neighbors, and links within said network based on information exchanged with other nodes; and
selecting a loop-free route according to a set of loop-free invariant (LFI) conditions.

20. A method as recited in claim 19, further comprising:
exchanging said distance and status information using messages containing at least one entry of the form [type, j, d];
wherein d is the distance of the node sending the message to destination j and type is the message type; and
wherein type is selected from a group of message types consisting essentially of QUERY, UPDATE, and REPLY.

21. A method as recited in claim 19:
wherein said diffusing computation is executed by sending query messages to neighbors with the best distance through the subset of neighboring nodes Sⁱⱼ.

22. A method as recited in claim 19:
wherein said nodes remain in a PASSIVE state and enter an ACTIVE state to engage in a diffusing computation; and
wherein if the increase in distance is the result of a query from a successor, said neighbor is added to the list of neighbors waiting for replies QSⁱⱼ to provide a reply when the node transitions to a PASSIVE state.

23. A method as recited in claim 19, wherein the information within said routing tables comprises:
distances to neighboring nodes;
successor sets for each destination, or equivalent;
feasible distance for each destination, or equivalent;
reported distance for each destination, or equivalent;
shortest possible distance through the successor set for each destination, or equivalent;
a set of neighbors engaged in a diffusing computation; and
cost of adjacent links.

24. A method as recited in claim 19, wherein said routing tables comprise a main table, a neighbor table, and a link table.

25. A method as recited in claim 24:
wherein said main table comprises storage for the link distance Dⁱⱼ to the destination.

26. A method as recited in claim 24:
wherein said main table comprises storage for successor set Sⁱⱼ, feasible distance FDⁱⱼ, reported distance RDⁱⱼ, and shortest distance through successor set SDⁱⱼ, and the set of neighbors involved in a diffusing computation QSⁱⱼ⊂Sⁱⱼ.

27. A method as recited in claim 24:
wherein said neighbor table for each neighbor which contains the distance of neighboring nodes to the destination Dⁱⱼₖ.

28. A method as recited in claim 24:
wherein said link table stores the cost of adjacent links to each neighbor lₖⁱ.

29. A method as recited in claim 28:
wherein if a link is down its cost is considered to be infinity and the distance to unreachable nodes is also considered to be infinity.

30. A method as recited in claim 19:
wherein said LFI conditions require that for each destination j, a node i can choose a successor whose distance to j, as known to i, is less than the distance of node i to j that is known to its neighbors.

31. A method as recited in claim 30, wherein said LFI conditions comprise:
FDⁱⱼ(t)≦D^{k}ⱼᵢ(t) while k∈Nⁱ;
where FDⁱⱼ(t) is the feasible distance from node i to node j at time t, D^{k}ⱼᵢ(t) is the distance of node j to node i as reported by neighbor k which is within the set of neighbors Nⁱ for node i;
where Sⁱⱼ(t)={k|Dⁱⱼₖ(t)<FDⁱⱼ(t)}; and
where Sⁱⱼ(t) is a subset of Nⁱ that node i forwards packets to node j, Dⁱⱼₖ(t) is the distance of node k to node j as reported by node i.

32. A method as recited in claim 19, further comprising executing a distributed Bellman-Ford (DBF) algorithm to compute said link distance.

33. A method as recited in claim 19, further comprising generating a routing graph for said nodes within said network;

34. A method of determining loop-free multipath routes within a network of interconnected router nodes executing a routing protocol, comprising:
executing a distributed Bellman-Ford (DBF) algorithm to compute link distance;
exchanging distance and status information between said nodes;
executing a diffusing computation if the distance of a link to a destination increases;
maintaining a set of routing tables containing information about distance, neighbors, and links within said network based on information exchanged with other nodes; and
selecting a loop-free route according to a set of loop-free invariant (LFI) conditions.

35. A method as recited in claim 34, further comprising generating a routing graph SGⱼ for said nodes within said network;

36. A method as recited in claim 34, further comprising:
exchanging said distance and status information using messages containing at least one entry of the form [type, j, d];
wherein d is the distance of the node sending the message to destination j and type is the message type; and
wherein type is selected from a group of message types consisting essentially of QUERY, UPDATE, and REPLY.

37. A method as recited in claim 34:
wherein said diffusing computation is executed by sending query messages to neighbors with the best distance through the subset of neighboring nodes Sⁱⱼ.

38. A method as recited in claim 34:
wherein said nodes remain in a PASSIVE state and enter an ACTIVE state to engage in a diffusing computation; and
wherein if the increase in distance is the result of a query from a successor, said neighbor is added to the list of neighbors waiting for replies QSⁱⱼ to provide a reply when the node transitions to a PASSIVE state.

39. A method as recited in claim 34, wherein the information within said routing tables comprises:
distances to neighboring nodes;
successor sets for each destination, or equivalent;
feasible distance for each destination, or equivalent;
reported distance for each destination, or equivalent;
shortest possible distance through the successor set for each destination, or equivalent;
a set of neighbors engaged in a diffusing computation; and
cost of adjacent links.

40. A method as recited in claim 34, wherein said routing tables comprise a main table, a neighbor table, and a link table.

41. A method as recited in claim 40:
wherein said main table comprises storage for the link distance Dⁱⱼ to the destination.

42. A method as recited in claim 40:
wherein said main table comprises storage for successor set Sⁱⱼ, feasible distance FDⁱⱼ, reported distance RDⁱⱼ, and shortest distance through successor set SDⁱⱼ, and the set of neighbors involved in a diffusing computation QSⁱⱼ⊂Sⁱⱼ.

43. A method as recited in claim 40:
wherein said neighbor table for each neighbor which contains the distance of neighboring nodes to the destination Dⁱⱼₖ.

44. A method as recited in claim 40:
wherein said link table stores the cost of adjacent links to each neighbor lₖⁱ.

45. A method as recited in claim 44:
wherein if a link is down its cost is considered to be infinity and the distance to unreachable nodes is also considered to be infinity.

46. A method as recited in claim 34:
wherein said LFI conditions require that for each destination i a node i can choose a successor whose distance to j, as known to i, is less than the distance of node i to j that is known to its neighbors.

47. A method as recited in claim 46, wherein said LFI conditions comprise:
FDⁱⱼ(t)≦D^{k}ⱼᵢ(t) while k∈Nⁱ;
where FDⁱⱼ(t) is the feasible distance from node i to node j at time t, D^{k}ⱼᵢ(t) is the distance of node I to node i as reported by neighbor k which is within the set of neighbors Nⁱ for node i;
where Sⁱⱼ(t)={k|Dⁱⱼₖ(t)<FDⁱⱼ(t)}; and
where Sⁱⱼ(t) is a subset of Nⁱ that node i forwards packets to node j, Dⁱⱼₖ(t) is the distance of node k to node j as reported by node i.

48. A method of determining loop-free multipath routes within a network of interconnected router nodes executing a routing protocol, comprising:
compute link distance between a source and destination;
exchanging distance and status information between said nodes;
executing a diffusing computation if the distance of a link to a destination increases;
maintaining a set of routing tables containing information about distance, neighbors, and links within said network based on information exchanged with other nodes; and
selecting a loop-free route according to a set of loop-free invariant (LFI) conditions;
wherein said LFI conditions comprise:
FDⁱⱼ(t)≦D^{k}ⱼᵢ(t) while k∈Nⁱ;
where FDⁱⱼ(t) is the feasible distance from node i to node j at time t, D^{k}ⱼᵢ(t) is the distance of node j to node i as reported by neighbor k which is within the set of neighbors Nⁱ for node i;
where Sⁱⱼ(t)={k|Dⁱⱼₖ(t)<FDⁱⱼ(t)}; and
where Sⁱⱼ(t) is a subset of Nⁱ that node i forwards packets to node j, Dⁱⱼₖ(t) is the distance of node k to node j as reported by node i.
